(19) United States
(12) Patent Application Publication
(10) Pub. No.: US 2025/0126013 A1
(43) Pub. Date: Apr. 17, 2025

(54) System and Method for Forecasting and Resolving Optical Component Failures

(71) Applicant: Dell Products L.P., Round Rock, TX (US)

(72) Inventors: Shaul Dar, Petach Tikva (IL); Arun Rameshbabu, Torbay (CA); Yosef Moshe Edo Hogeg, Beer Sheva (IL); Lev Makler, Beer Sheva (IL); Keith Drummond, Cork (IE); Daniel McKay, Waltham, MA (US); Timothy O'Connor, Cork (IE)

(21) Appl. No.: 18/486,326

(22) Filed: Oct. 13, 2023

(51) Int. Cl. H04L 41/0686; H04B 10/079; H04Q 11/00

(52) U.S. Cl. CPC H04L 41/0686; H04B 10/07955; H04Q 2011/0081; H04Q 2011/0083

(57) ABSTRACT

A method, computer program product, and computing system for processing telemetry data associated with a small form factor pluggable (SFP) transceiver. A SFP transceiver failure associated with the SFP transceiver is forecasted using a machine learning model. A remedial action is performed in response to forecasting the SFP transceiver failure associated with the SFP transceiver.

### BACKGROUND

The use of Fibre Channel (FC) networking technology and related components is becoming more and more prevalent in advanced storage and IT systems, replacing older protocols such as SCSI, and providing a reliable and scalable high-throughput and low-latency protocol and interface. Fibre Channel is especially suited for connecting servers to shared storage devices and interconnecting storage controllers and drive. FC is based on optical data transmission. The FC cables are attached to the relevant hardware units via a Small Form Factor Pluggable (SFP) module. SFPs and related optical components are prone to failure. The main cause for such failures is generally optical slot contamination, oxidation, and resulting damages. Such failures are often the culmination of gradual deterioration over time.

### Summary of Disclosure

In one example implementation, a computer-implemented method executed on a computing device may include, but is not limited to, processing telemetry data associated with a small form factor pluggable (SFP) transceiver. A SFP transceiver failure associated with the SFP transceiver is forecasted using a machine learning model. A remedial action is performed in response to forecasting the SFP transceiver failure associated with the SFP transceiver.

One or more of the following example features may be included. Processing the telemetry data associated with the SFP transceiver may include monitoring transmission power information associated with the SFP transceiver over a defined period of time. Processing the telemetry data associated with the SFP transceiver may include monitoring receiver power information associated with the SFP transceiver over a defined period of time. Forecasting the SFP transceiver failure associated with the SFP transceiver may include forecasting when the SFP transceiver performance will cross a manufacture performance threshold indicative of failure. Forecasting the SFP transceiver failure associated with the SFP transceiver may include forecasting when the SFP transceiver will be replaced. Performing the remedial action may include generating a recommendation to replace the SFP transceiver in advance of the forecast SFP transceiver failure. Performing the remedial action may include generating a recommendation to replace a plurality of components from a storage system including the SFP transceiver with the forecast SFP transceiver failure.

In another example implementation, a computer program product resides on a computer readable medium that has a plurality of instructions stored on it. When executed by a processor, the instructions cause the processor to perform operations that may include, but are not limited to, processing telemetry data associated with a small form factor pluggable (SFP) transceiver. A SFP transceiver failure associated with the SFP transceiver is forecasted using a machine learning model. A remedial action is performed in response to forecasting the SFP transceiver failure associated with the SFP transceiver.

One or more of the following example features may be included. Processing the telemetry data associated with the SFP transceiver may include monitoring transmission power information associated with the SFP transceiver over a defined period of time. Processing the telemetry data associated with the SFP transceiver may include monitoring receiver power information associated with the SFP transceiver over a defined period of time. Forecasting the SFP transceiver failure associated with the SFP transceiver may include forecasting when the SFP transceiver performance will cross a manufacture performance threshold indicative of failure. Forecasting the SFP transceiver failure associated with the SFP transceiver may include forecasting when the SFP transceiver will be replaced. Performing the remedial action may include generating a recommendation to replace the SFP transceiver in advance of the forecast SFP transceiver failure. Performing the remedial action may include generating a recommendation to replace a plurality of components from a storage system including the SFP transceiver with the forecast SFP transceiver failure.

In another example implementation, a computing system includes at least one processor and at least one memory architecture coupled with the at least one processor, wherein the at least one processor is configured to process telemetry data associated with a small form factor pluggable (SFP) transceiver. A SFP transceiver failure associated with the SFP transceiver is forecasted using a machine learning model is forecasted. A remedial action is performed in response to forecasting the SFP transceiver failure associated with the SFP transceiver.

One or more of the following example features may be included. Processing the telemetry data associated with the SFP transceiver may include monitoring transmission power information associated with the SFP transceiver over a defined period of time. Processing the telemetry data associated with the SFP transceiver may include monitoring receiver power information associated with the SFP transceiver over a defined period of time. Forecasting the SFP transceiver failure associated with the SFP transceiver may include forecasting when the SFP transceiver performance will cross a manufacture performance threshold indicative of failure. Forecasting the SFP transceiver failure associated with the SFP transceiver may include forecasting when the SFP transceiver will be replaced. Performing the remedial action may include generating a recommendation to replace the SFP transceiver in advance of the forecast SFP transceiver failure. Performing the remedial action may include generating a recommendation to replace a plurality of components from a storage system including the SFP transceiver with the forecast SFP transceiver failure.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and an optical component failure forecasting process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of optical component failure forecasting process according to one or more example implementations of the disclosure;

FIG. 4 is an example diagrammatic view of the storage system of FIG. 1 including small form factor pluggable (SFP) transceivers according to one or more example implementations of the disclosure;

FIG. 5 is an example diagrammatic view of the optical component failure forecasting process according to one or more example implementations of the disclosure;

FIG. 6 is an example plot of the forecasting of a SFP failure compared to a manufacturer performance threshold according to one or more example implementations of the disclosure; and

FIG. 7 is an example remedial action in the form of a user interface alerting a user of a forecasted SFP transceiver failure according to one or more example implementations of the disclosure.

Like reference symbols in the various drawings indicate like elements.

### DETAILED DESCRIPTION

### System Overview

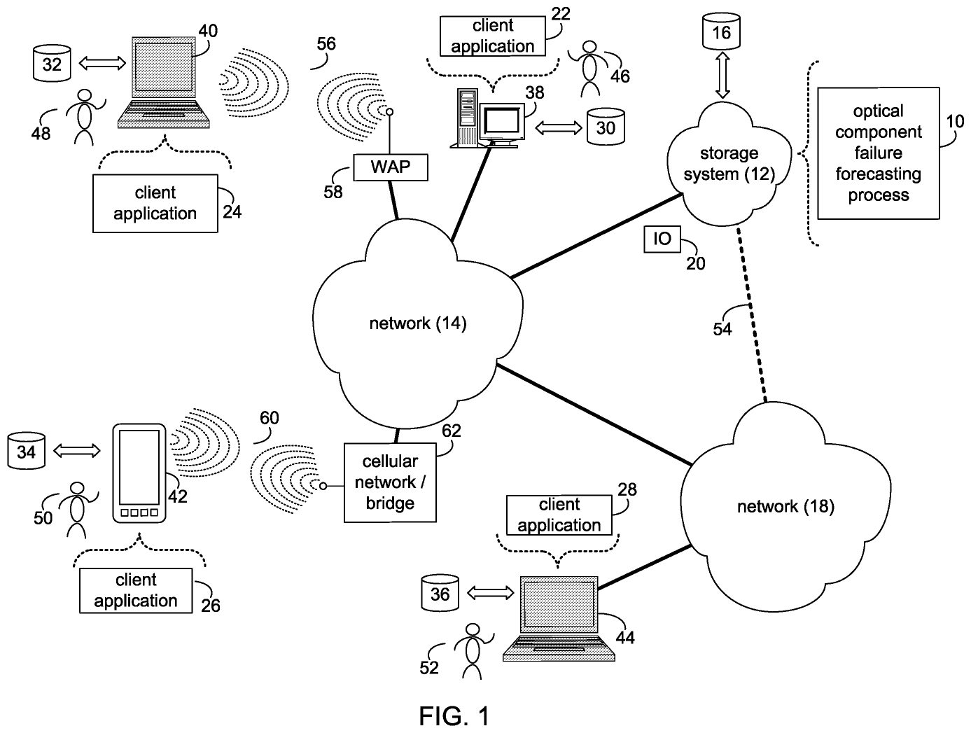

Referring to FIG. 1, there is shown optical component failure forecasting process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of optical component failure forecasting process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of optical component failure forecasting process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an optical component failure forecasting process, such as optical component failure forecasting process 10 of FIG. 1, may include but is not limited to, processing telemetry data associated with a small form factor pluggable (SFP) transceiver. A SFP transceiver failure associated with the SFP transceiver is forecasted using a machine learning model. A remedial action is performed in response to forecasting the SFP transceiver failure associated with the SFP transceiver.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

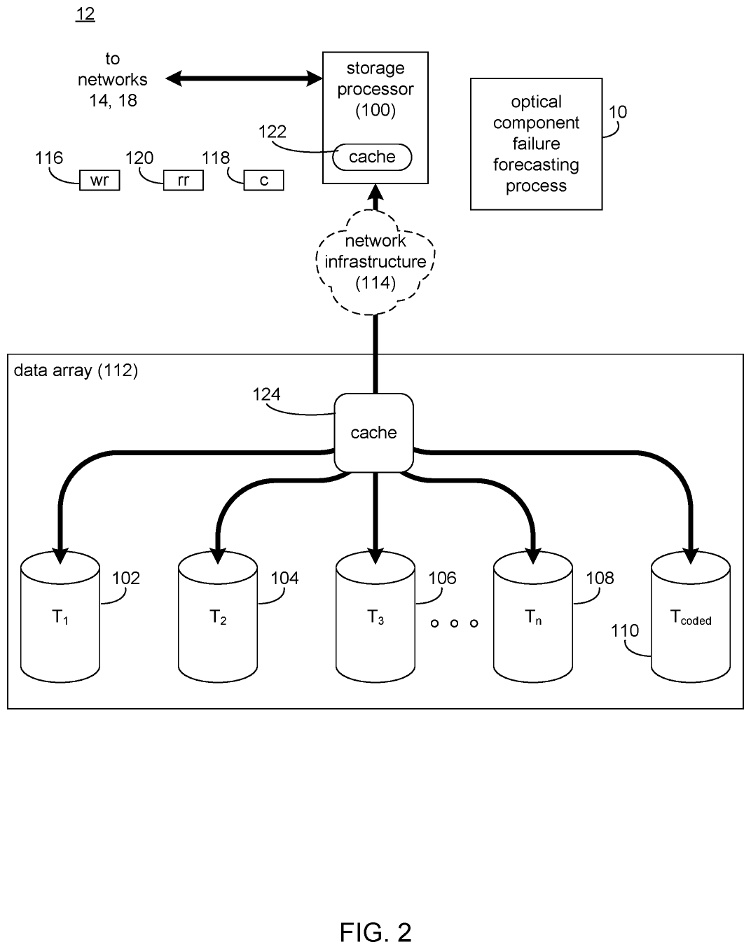

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of optical component failure forecasting process 10. The instruction sets and subroutines of optical component failure forecasting process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of optical component failure forecasting process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g., one or more of storage targets 102, 104, 106, 108, and coded target 110.

As discussed above, the instruction sets and subroutines of optical component failure forecasting process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of optical component failure forecasting process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

### The Optical Component Failure Forecasting Process:

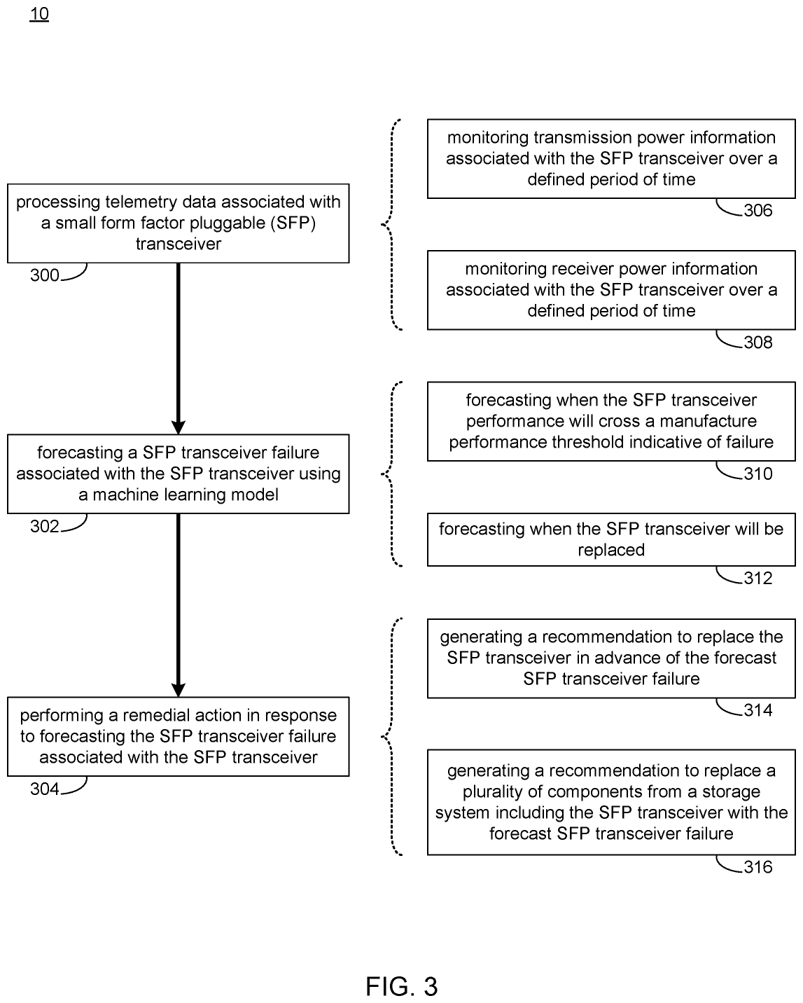

Referring also to the examples of FIGS. 3-6 and in some implementations, optical component failure forecasting process 10 may process 300 telemetry data associated with a small form factor pluggable (SFP) transceiver. A SFP transceiver failure associated with the SFP transceiver is forecasted 302 using the machine learning model. A remedial action is performed 304 in response to forecasting the SFP transceiver failure associated with the SFP transceiver.

As will be discussed in greater detail below, implementations of the present disclosure may allow for automated calibration of time dependent IO features using a standard benchmark methodology. As discussed above, the use of Fibre Channel (FC) networking technology and related components is becoming more and more prevalent in advanced storage and IT systems, replacing older protocols such as SCSI, and providing a reliable and scalable high-throughput and low-latency protocol and interface. Fibre Channel is especially suited for connecting servers to shared storage devices and interconnecting storage controllers and drive. FC is based on optical data transmission. The FC cables are attached to the relevant hardware units via a Small Form Factor Pluggable (SFP) module.

SFPs and related optical components are prone to failure. The main cause for such failures is generally optical slot contamination, oxidation, and resulting damages. Such failures are often the culmination of gradual deterioration over time and can be forecasted using relevant historical telemetry and suitable machine learning forecasting algorithms. Accurate forecasting can enable practical solutions such as proactive replacements, batch replacements, and enabling customers to perform self-replacement, all of which can save money and minimize storage system disruption for repairs.

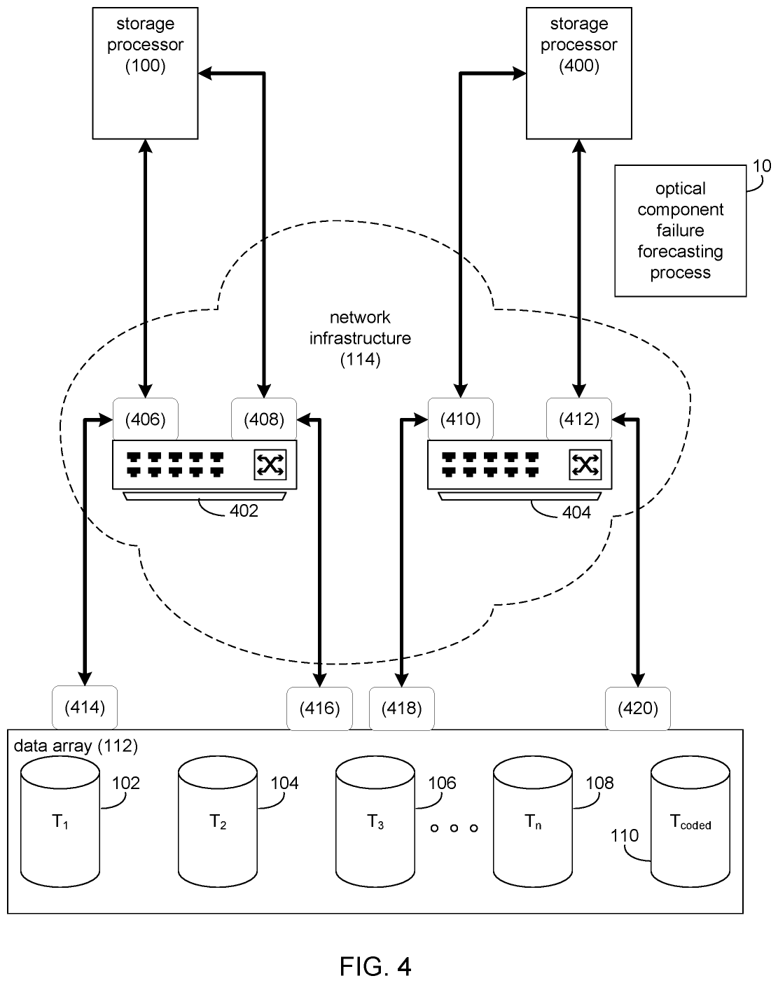

In some implementations, optical component failure forecasting process 10 processes 300 telemetry data associated with a small form factor pluggable (SFP) transceiver. For example, a SFP transceiver is a compact, hot-pluggable network interface module format used for both telecommunication and data communications applications. Referring also to FIG. 4, suppose a storage environment includes storage processors 100, 400; network switches (e.g., network switches 402, 404); and data array 112. In this example, suppose network switch 402 includes SFP transceivers 406, 408 and network switch 404 includes SFP transceivers 410, 412. Further suppose that data array 112 has SFP transceivers 414, 416, 418, 420 coupled to network switches 402, 404. Optical component failure forecasting process 10 may process telemetry data associated with each respective SFP transceiver (e.g., SFP transceivers 414, 416, 418, 420).

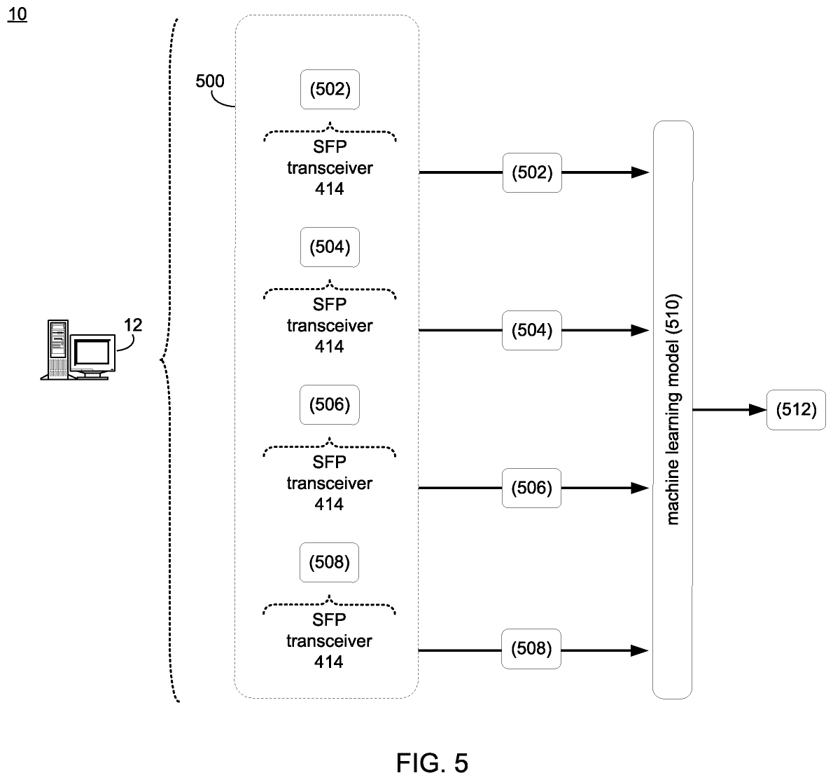

In some implementations, optical component failure forecasting process 10 processes 300 telemetry data associated with a SFP transceiver. For example and referring also to FIG. 5, optical component failure forecasting process 10 may process a plurality of telemetry data (e.g., plurality of telemetry data 500) associated with an SFP transceiver (e.g., SFP transceiver 414). Telemetry data generally includes information concerning the operation of the SFP transceiver (e.g., transceiver temperature, internally measured supply voltage, transmitter bias current, transmitter output power and received optical power). In some implementations, telemetry data 500 is collected to a central cloud location and for parsing and analysis. As will be discussed in greater detail below, telemetry data 500 may be joined with the vendor and device-specific information for forecasting a SFP transceiver failure.

In some implementations, processing 300 the telemetry data associated with the SFP transceiver includes monitoring 306 transmission power information associated with the SFP transceiver over a defined period of time. Transmission power information may generally include transmitter output power, transmitter bias current, transmitter voltage, etc. Monitoring the transmission power information may generally include processing telemetry data associated with transmission power information for the SFP transceiver. Returning to the example of FIG. 5, telemetry data 502 may include information concerning transmission power associated with SFP transceiver 414. For example, telemetry data 502 may concern the transmitter output power at a certain point in time while telemetry data 504 may concern the transmitter output power at a later point in time (e.g., after a predefined period of time). Similarly, telemetry data 506 and 508 may concern additional time samples of the transmitter power. Accordingly and as will be discussed in greater detail below, optical component failure forecasting process 10 processes transmission power information over time to forecast a SFP transceiver failure. For example, SFP transmitter power may increase over time as optical components degrade or oxidize-requiring more transmitter power to successfully transmit the same data. As such, optical component failure forecasting process 10 may monitor 306 transmission power information associated with the SFP transceiver over a defined period of time for forecasting SFP transceiver failure.

In some implementations, processing 300 the telemetry data associated with the SFP transceiver includes monitoring 308 receiver power information associated with the SFP transceiver over a defined period of time. Transmission power information may generally include transmitter output power, transmitter bias current, transmitter voltage, etc. Monitoring the transmission power information may generally include processing telemetry data associated with transmission power information for the SFP transceiver. Returning again to the example of FIG. 5, telemetry data 502 may include information concerning receiver power associated with SFP transceiver 414. For example, telemetry data 502 may concern the receiver input power (i.e., the power of the signal received at the receiver) at a certain point in time while telemetry data 504 may concern the receiver input power at a later point in time (e.g., after a predefined period of time). Similarly, telemetry data 506 and 508 may concern additional time samples of the receiver input power. Accordingly and as will be discussed in greater detail below, optical component failure forecasting process 10 processes receiver power information over time to forecast a SFP transceiver failure. For example, SFP receiver power may decrease over time as optical components degrade or oxidize. As such, optical component failure forecasting process 10 may monitor 308 receiver power information associated with the SFP transceiver over a defined period of time for forecasting SFP transceiver failure.

In some implementations, optical component failure forecasting process 10 forecasts 302 a SFP transceiver failure associated with the SFP transceiver using a machine learning model. A machine learning model may generally include an algorithm or combination of algorithms that has been trained to recognize certain types of patterns. For example, machine learning approaches may be generally divided into three categories, depending on the nature of the signal available: supervised learning, unsupervised learning, and reinforcement learning. Supervised learning may include presenting a computing device with example inputs and their desired outputs, given by a “teacher”, where the goal is to learn a general rule that maps inputs to outputs. With unsupervised learning, no labels are given to the learning algorithm, leaving it on its own to find structure in its input. Unsupervised learning can be a goal in itself (discovering hidden patterns in data) or a means towards an end (feature learning). Reinforcement learning may generally include a computing device interacting in a dynamic environment in which it must perform a certain goal (such as driving a vehicle or playing a game against an opponent). As it navigates its problem space, the machine learning model is provided feedback that is analogous to rewards, which it tries to maximize. While three examples of machine learning approaches have been provided, it will be appreciated that other machine learning approaches are possible within the scope of the present disclosure.

In some implementations, forecasting 302 a SFP transceiver failure generally includes predicting when (in a predefined period of time) the SFP transceiver will experience a failure. For example, optical component failure forecasting process 10 may process 300 telemetry data 502, 504, 506, 508 using a machine learning model (e.g., machine learning model 510). Machine learning model 510 may be trained to process telemetry data concerning the SFP transceiver to forecast a point in time when the SFP transceiver will experience a failure. In some implementations, a SFP transceiver failure forecast (e.g., SFP transceiver failure forecast 512) may be a point in time (e.g., an hour, a day, a week, a month, and/or a year) when a given SFP transceiver is predicted to fail.

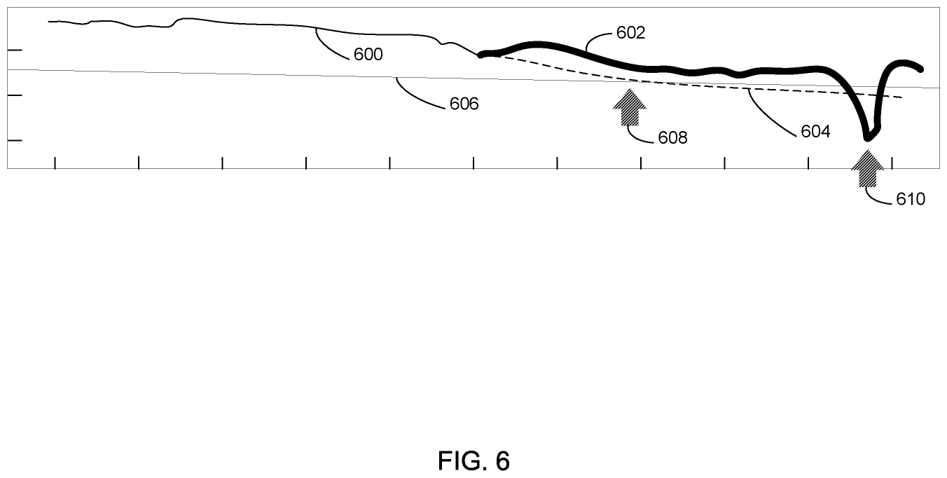

In some implementations, forecasting 302 the SFP transceiver failure associated with the SFP transceiver includes forecasting 310 when the SFP transceiver performance will cross a manufacture performance threshold indicative of failure. For example and referring also to FIG. 6, a plot of time series values for SFP receiver input power (e.g., where the x-axis represents time and the y-axis represents receiver input power (i.e., the power of the signal received at the receiver)). In the example of FIG. 6, line 600 represents historical time series data for SFP transceiver receiver input power used to train machine learning model 510; line 602 represents actual time series data for the SFP transceiver receiver input power; and line 604 represents the forecast time series values for the SFP transceiver input power. In some implementations, when forecasting 302 when the SFP transceiver will fail, optical component failure forecasting process 10 may forecast 310 when the SFP transceiver performance will cross a manufacture performance threshold indicative of failure.

In the example of FIG. 6, a manufacturer performance threshold for SFP transceiver receiver input power is represented as line 606. As shown in FIG. 6, optical component failure forecasting process 10 may forecast 300 a SFP transceiver failure as the point in time (e.g., SFP transceiver failure 608) when the forecast time series values for the SFP transceiver input power (e.g., line 604) crosses the manufacturer performance threshold (e.g., line 606). By forecasting SFP transceiver failure 608 when the forecast time series values for the SFP transceiver input power (e.g., line 604) crosses the manufacturer performance threshold (e.g., line 606), optical component failure forecasting process 10 provides an early warning for the actual SFP transceiver failure (e.g., SFP transceiver failure 610).

In some implementations, forecasting 302 the SFP transceiver failure associated with the SFP transceiver includes forecasting 312 when the SFP transceiver will be replaced. For example, SFP transceiver failure may not only be indicative of actual SFP transceiver failure (i.e., a degradation in SFP transceiver performance relative to particular transceiver thresholds) but may also be indicative of when an SFP transceiver is likely to be replaced. For example, suppose SFP transceiver 414 is scheduled to be replaced at a certain point in time. In this example, optical component failure forecasting process 10 may forecast 312 the SFP transceiver failure for SFP transceiver 414 as the certain point in time when SFP transceiver 414 is scheduled to be replaced. In another example, suppose SFP transceiver 414 is scheduled to be replaced when SFP transceiver 414 has performed a certain amount of transmitting and/or receiving (e.g., a threshold amount of time active, a threshold amount of data processed, etc.). In this example, optical component failure forecasting process 10 may forecast 312 the SFP transceiver failure for SFP transceiver 414 as the point in time when SFP transceiver 414 is scheduled to perform the threshold amount of transmitting and/or receiving.

In some implementations, optical component failure forecasting process 10 performs 304 a remedial action in response to forecasting the SFP transceiver failure associated with the SFP transceiver. For example, performing 304 a remedial action in response to forecasting the SFP transceiver failure may generally include automatically initiating a remedial action or alerting a user (e.g., a storage system user or storage system administrator) to perform a remedial action. A remedial action may generally include an action that replaces the SFP transceiver for which the SFP transceiver failure is forecasted or that resolves the forecast SFP transceiver failure (e.g., by scheduling service, performing troubleshooting, etc.).

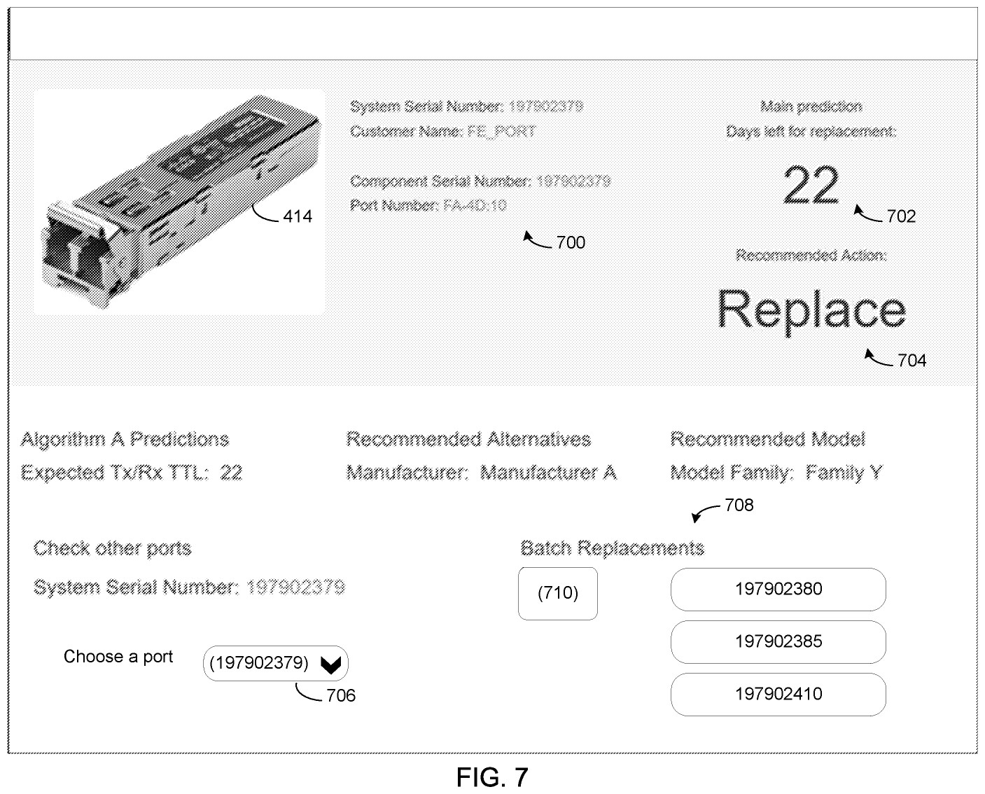

In some implementations, performing 304 the remedial action includes generating 314 a recommendation to replace the SFP transceiver in advance of the forecast SFP transceiver failure. For example and referring also to FIG. 7, suppose that optical component failure forecasting process 10 forecasts that SFP transceiver 414 is forecasted to fail at a certain point in time. In this example, optical component failure forecasting process 10 may generate 314 a recommendation to replace SFP transceiver 414 as shown in FIG. 7 with information concerning SFP transceiver 414 (e.g., SFP transceiver information 700); a representation of the predicted conditions for SFP transceiver failure (e.g., countdown 702); and a recommended action (e.g., recommended action 704 to “Replace” SFP transceiver 414). In some implementations, recommended action 704 may be an automatically initiated action (e.g., performed automated troubleshooting or rebooting of the SFP transceiver) or may be a recommended action for a user to perform (e.g., an instruction on when and how to replace the SFP transceiver). For example, optical component failure forecasting process 10 may access a database of rules and conditions for providing specific recommendations from a plurality of possible recommendations. Optical component failure forecasting process 10 may compare the SFP transceiver forecast information against various metrics to determine what type of action is recommended to perform on the SFP transceiver that is forecasted to fail. In some examples, optical component failure forecasting process 10 may generate 314 a recommendation in the form of an alert broadcast to one or more computing devices and/or a pop-up message or user interface as shown in FIG. 7. In this manner, optical component failure forecasting process 10 may generate 314 a recommendation that alerts a user to perform a particular remedial action or of an action that is automatically being implemented.

In some implementations, performing 304 the remedial action includes generating 316 a recommendation to replace a plurality of components from a storage system including the SFP transceiver with the forecast SFP transceiver failure. Referring again to FIG. 7, optical component failure forecasting process 10 may generate 316 a recommendation in the form of an interactive user interface with various features. For example, the recommendation may include an option (e.g., option 706) to select or switch between SFP transceivers of a storage system. In another example, optical component failure forecasting process 10 may generate 316 a recommendation to replace a plurality of components from the storage system. For example, the user interface of FIG. 7 may include options for batch replacements (e.g., batch replacement information 708). In this example, a user may select an option (e.g., option 710) to identify a plurality of components (e.g., SFP transceivers and other components that may influence SFP transceiver performance) to replace in response to forecasting the SFP transceiver failure. As shown in the example of FIG. 7, optical component failure forecasting process 10 generates 316 a recommendation to replace a plurality of SFP transceivers that are forecasted to fail within a threshold amount of time (e.g., a user-defined threshold, a default amount of time, etc.) of SFP transceiver 414. In this manner, optical component failure forecasting process 10 generates 316 recommendations to perform batches of remedial actions to increase the efficiency of any singular remedial action.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
processing telemetry data associated with a small form factor pluggable (SFP) transceiver;
forecasting a SFP transceiver failure associated with the SFP transceiver using a machine learning model; and
performing a remedial action in response to forecasting the SFP transceiver failure associated with the SFP transceiver.

2. The computer-implemented method of claim 1, wherein processing the telemetry data associated with the SFP transceiver includes monitoring transmission power information associated with the SFP transceiver over a defined period of time.

3. The computer-implemented method of claim 1, wherein processing the telemetry data associated with the SFP transceiver includes monitoring receiver power information associated with the SFP transceiver over a defined period of time.

4. The computer-implemented method of claim 1, wherein forecasting the SFP transceiver failure associated with the SFP transceiver includes forecasting when the SFP transceiver performance will cross a manufacture performance threshold indicative of failure.

5. The computer-implemented method of claim 1, wherein forecasting the SFP transceiver failure associated with the SFP transceiver includes forecasting when the SFP transceiver will be replaced.

6. The computer-implemented method of claim 1, wherein performing the remedial action includes generating a recommendation to replace the SFP transceiver in advance of the forecast SFP transceiver failure.

7. The computer-implemented method of claim 1, wherein performing the remedial action includes generating a recommendation to replace a plurality of components from a storage system including the SFP transceiver with the forecast SFP transceiver failure.

8. A computer program product residing on a non-transitory computer readable medium having a plurality of instructions stored thereon which, when executed by a processor, cause the processor to perform operations comprising:
processing telemetry data associated with a small form factor pluggable (SFP) transceiver;
forecasting a SFP transceiver failure associated with the SFP transceiver using a machine learning model; and
performing a remedial action in response to forecasting the SFP transceiver failure associated with the SFP transceiver.

9. The computer program product of claim 8, wherein processing the telemetry data associated with the SFP transceiver includes monitoring transmission power information associated with the SFP transceiver over a defined period of time.

10. The computer program product of claim 8, wherein processing the telemetry data associated with the SFP transceiver includes monitoring receiver power information associated with the SFP transceiver over a defined period of time.

11. The computer program product of claim 8, wherein forecasting the SFP transceiver failure associated with the SFP transceiver includes forecasting when the SFP transceiver performance will cross a manufacture performance threshold indicative of failure.

12. The computer program product of claim 8, wherein forecasting the SFP transceiver failure associated with the SFP transceiver includes forecasting when the SFP transceiver will be replaced.

13. The computer program product of claim 8, wherein performing the remedial action includes generating a recommendation to replace the SFP transceiver in advance of the forecast SFP transceiver failure.

14. The computer program product of claim 8, wherein performing the remedial action includes generating a recommendation to replace a plurality of components from a storage system including the SFP transceiver with the forecast SFP transceiver failure.

15. A computing system comprising:
a memory; and
a processor configured to process telemetry data associated with a small form factor pluggable (SFP) transceiver, to forecast a SFP transceiver failure associated with the SFP transceiver using a machine learning model, and to perform a remedial action in response to forecasting the SFP transceiver failure associated with the SFP transceiver.

16. The computing system of claim 15, wherein processing the telemetry data associated with the SFP transceiver includes monitoring transmission power information associated with the SFP transceiver over a defined period of time.

17. The computing system of claim 15, wherein processing the telemetry data associated with the SFP transceiver includes monitoring receiver power information associated with the SFP transceiver over a defined period of time.

18. The computing system of claim 15, wherein forecasting the SFP transceiver failure associated with the SFP transceiver includes forecasting when the SFP transceiver performance will cross a manufacture performance threshold indicative of failure.

19. The computing system of claim 15, wherein forecasting the SFP transceiver failure associated with the SFP transceiver includes forecasting when the SFP transceiver will be replaced.

20. The computing system of claim 15, wherein performing the remedial action includes generating a recommendation to replace the SFP transceiver in advance of the forecast SFP transceiver failure.
